(19) United States
(12) Patent Application Publication
(10) Pub. No.: US 2026/0093852 A1
(43) Pub. Date: Apr. 2, 2026

(54) Voltage Glitch Attack Detector

(71) Applicant: Nuvoton Technology Corporation, Hsin-chu (TW)

(72) Inventors: Yuval Kirschner, Even Yehuda (IL); Tamir Golan, Kibbutz Givaat-Chaim Meuchad (IL)

(21) Appl. No.: 18/903,003

(22) Filed: Oct. 1, 2024

(51) Int. Cl. G06F 21/75; G06F 21/56

(52) U.S. Cl. CPC G06F 21/755; G06F 21/567; G06F 2221/034

(57) ABSTRACT

An electronic device includes a power-supply input, a protected circuit and a voltage sense circuit, The protected circuit is configured to draw current from the power-supply input, thereby obtaining from the power-supply input an operational voltage waveform. The voltage sense circuit is configured to receive, from the power-supply input, a sense voltage waveform that differs from the operational voltage waveform, via a second electrical connection that is separate from the first electrical connection, and to detect a security attack on the protected circuit responsively to the sense voltage waveform.

### FIELD OF THE INVENTION

The present invention relates to security of Electronic Devices, and, particularly to methods and apparatuses to allow detection of voltage-supply side-channel attacks.

### BACKGROUND OF THE INVENTION

Attackers that seek to extract secret data from an integrated circuit (IC) sometimes use voltage side-channel error-injection attacks. Some background regarding glitch-detection side-channel attacks may be found in U.S. Patent Application Publication 2023/0102249, which discloses a method, including selecting an impedance threshold for a battery in electrical communication with an integrated circuit; acquiring an impedance of the battery; calculating an average impedance of the battery for a period of time; determining whether the integrated circuit is a victim of a power side channel attack if the average impedance of the battery for the period of time exceeds the impedance threshold; and responding to the power side channel attack.

U.S. Patent Application Publication 2024/0005045 discloses a system on chip comprising a memory controller having a clock synchronization circuitry based on a locked loop. The system on chip further comprises a voltage glitch attack detector configured to monitor a clock synchronization signal generated by the clock synchronization circuitry and check whether the monitored clock synchronization signal is a nominal signal or a signal characteristic of a voltage glitch attack. The voltage glitch attack detector may be a software detector executed by a processing unit.

U.S. Patent 9,523,722 discloses a monolithic integrated circuit device, including a supply voltage glitch detector for detecting improper supply voltage conditions. The detection threshold of the supply voltage glitch detector is adaptively set based on the mode of operation of the device or a particular part of the device, which is internally known to the device based on certain inputs received by the device, such as commands, interrupts, control signals, and so forth.

### SUMMARY OF THE INVENTION

An embodiment of the present invention provides an electronic device including a power-supply input, a protected circuit and a voltage sense circuit. The protected circuit is configured to draw current from the power-supply input, thereby obtaining from the power-supply input an operational voltage waveform. The voltage sense circuit is configured to receive, from the power-supply input, a sense voltage waveform that differs from the operational voltage waveform, via a second electrical connection that is separate from the first electrical connection, and to detect a security attack on the protected circuit responsively to the sense voltage waveform.

In some embodiments, the first electrical connection includes a first number of bonding wires, and the second electrical connection includes a second number of bonding wires.

In an embodiment, the voltage sense circuit is configured to detect the security attack responsively to the sense voltage waveform and to a comparison of the sense voltage waveform and the operational voltage waveform. In an alternative embodiment, the voltage sense circuit is configured to detect the security attack based on the sense voltage waveform, independently of the operational voltage waveform.

In some embodiments, the voltage sense circuit is configured to initiate a security protection measure responsively to detecting the security attack.

There is additionally provided, in accordance with an embodiment that is described herein, a method including, in a protected circuit in an electronic device, drawing current from a power-supply input, thereby obtaining from the power-supply input an operational voltage waveform. A sense voltage waveform is received from the power-supply input in a voltage sense circuit in the electronic device. The sense voltage waveform differs from the operational voltage waveform, and is received via a second electrical connection that is separate from the first electrical connection. A security attack on the protected circuit is detected responsively to the sense voltage waveform.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an attack-resilient electronic device, in accordance with an embodiment of the present invention;

FIG. 2 is a block diagram that schematically illustrates a differential-detection attack-resilient electronic device, in accordance with an embodiment of the present invention; and

FIG. 3 is a flowchart that schematically illustrates a method for security attack detection, in accordance with an embodiment of the present invention.

### DETAILED DESCRIPTION OF EMBODIMENTS

### Overview

Electronic devices sometimes comprise sensitive data, such as passwords, authentication keys, encryption keys and others.

To gain unauthorized access to the sensitive data, hackers sometimes use side-channel attacks, including, for example, monitoring of a power consumption of the IC, timing measurement attacks, electromagnetic and acoustic radiation signature attacks, and others.

One class of attacks is error injection, wherein a hacker injects faults into the IC (referred to as “glitches”) in an attempt to bypass security measures that the IC may include, or otherwise transition the IC into an abnormal state that enables revealing sensitive information. We will relate below to security attacks that comprise noise injection into the power input of the IC (“power supply noise-injection”).

When the IC is packaged, the hacker may not be able to directly access the power input of the IC but, rather, inject errors through a power-supply input of the IC package, which is connected to the IC through one or more Bonding Wires. It should be noted that power-supply input pins may comprise the actual supply pins and may, sometimes, comprise pins for filtering capacitors used by the on-chip Low Dropout (LDO) regulator. Fault injection may be done through both types. We refer below to both types as “Vdd”.

Embodiments of the present invention that are disclosed herein provide for circuits and methods that detect security attacks and, responsively, take protection measures. In an embodiment, the IC comprises a Protected Circuit, (which may handle secret data) and a Sense Circuit; the power supply of the Protected Circuit is connected to a Vdd trace in the Printed Circuit Board (PCB), through one or more Bonding Wires (the voltage on the power input of the protected circuit is referred to as the Operational Voltage). (In embodiments, PCB refers to the BGA package substrate PCB rather than the board on which the chip is mounted.)

To inject substantial glitches (that are strong enough to potentially disrupt the operation of the Protected Circuit) at the power supply input of the Protected Circuit, the Hacker must, Due to the inductance of the Bonding Wires, inject much larger glitches on the Vdd trace in the PCB.

In some embodiments, the Vdd trace in the PCB is connected, through a separate Bonding Wire (or a group of Bonding Wires), to a Sense Circuit, that detects security attacks (e.g., glitches on the Vdd Trace), and takes a protection measure if an attack is detected. In embodiments, the Sense Circuit may alternatively or additionally compare the voltage at the input of the Protected circuit to the voltage on the Vdd trace in the PCB.

### System Description

We refer in the disclosure below to Electronic Devices that comprise an Integrated Circuit (IC), which, in turn, comprises one or more sensitive circuits that should be protected against unauthorized access (“Protected Circuit”). In embodiments, the Electronic Device comprises circuitry to detect side-channel attacks that comprise electrical noise injection through the power supply input of the Electronic Device. In some embodiments, the IC is connected to the power supply input of the Electronic Device through one or more Bonding Wires.

We refer to a person or an entity that attempts to gain unauthorized access to data in the Electronic Device as a Hacker.

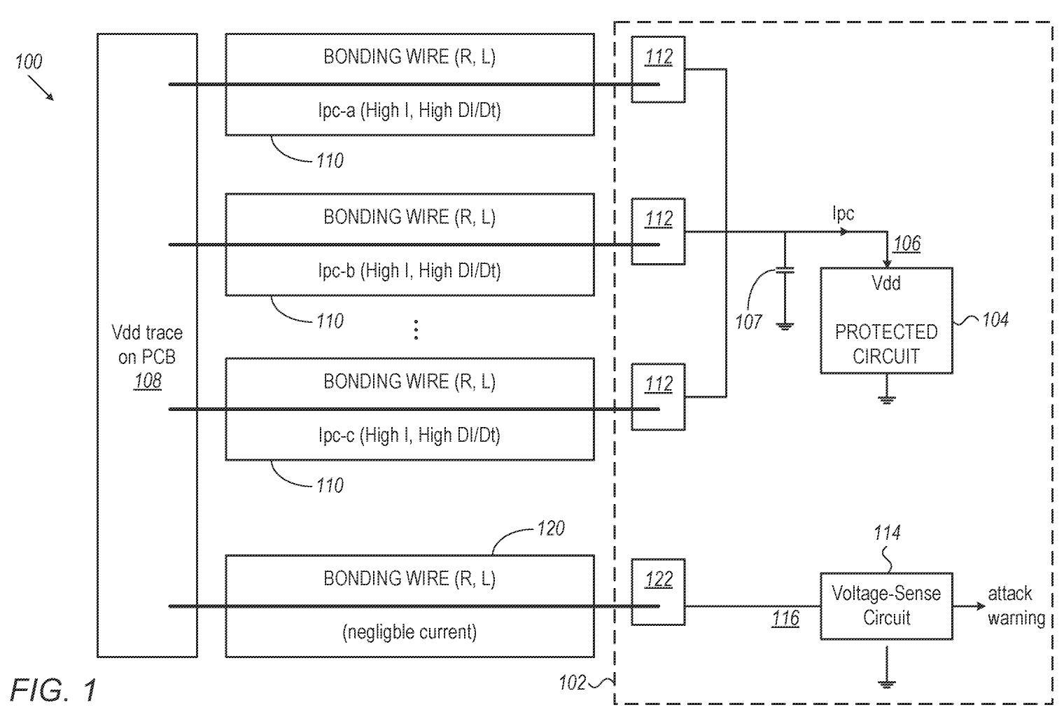

FIG. 1 is a block diagram that schematically illustrates an Attack-Resilient Electronic Device 100, in accordance with an embodiment of the present invention. Electronic Device 100 comprises an IC 102 which, in turn, comprises a Protected Circuit 104 that may store secret data, such as encryption keys, passwords, signatures, and others. (It should be clarified that, in the current context, the term “Protected Circuit” refers to any circuit that includes or handles secret data, including complex processor cores that run complex computations or communication tasks, but may occasionally handle secret data.)

Protected Circuit 104 comprises a Power-Supply Input 106, which is coupled to ground through an integrated Noise-Decoupling Capacitor 107 (note that Capacitor 107 includes the on-IC decoupling capacitance and does not include any off-IC capacitors, which can be disconnected by the Hacker). In some embodiments, a regulator (e.g., a Low-dropout Regulator (LDO)) is used instead of or in addition to Capacitor 107. In an embodiment, when an LDO is used, the electronic device 100 may comprise an external filtering capacitor that is connected to a dedicated pin in the package.

The supply current to the Protected Circuit through Power-Supply Input 106 is designated Ipc. The voltage on Power-Supply Input 106 is referred to as the Operational Voltage.

Hackers may try to induce glitches or abnormal voltage levels on the Power-Supply Input 106, hoping to bypass data protection mechanisms that Protected Circuit 104 may have. For example, a glitch may alter the Program Counter of a processor in the Protected Circuit, and, thus, potentially, bypass any protection software code (In the description herein below, we will use the term “Security Attacks” for such noise-injection attempts, although the term Security Attack usually includes many other types of attacks).

A Hacker, however, can typically access the IC package pins only, and cannot directly access the Power-Supply Input 106 within IC 102. A PCB Vdd-Trace 108 is connected to IC 102 through an electrical connection. According to the example embodiment illustrated in FIG. 1, the electrical connection comprises Bonding Wires 110 that are connected to Pads 112 of the IC 102. Alternatively, any other suitable type of electrical connection can be used (when an off-IC LDO filtering capacitor is used, the Hacker may use the decoupling capacitor pin or the Vdd input pin for glitch insertion, typically after removing the filtering capacitor).

Pads 112 are connected, within the IC, to the Power-Supply Input 106 of Protected Circuit 104. In embodiments, the impedance of each of Bonding Wires 110 comprises a resistance and an inductance in the range of tens of milli-Ohm and several nano-Henry, respectively. To decrease the resistance and inductance, three Bonding Wires 110 are connected in parallel (any other suitable number of Bonding Wires may be used in alternative embodiments).

We refer to the waveform over time of the Operational Voltage (on Power Supply Input 106) as Operational Voltage Waveform. In embodiments, the supply current Ipc of the Protected Circuit 104 is relatively high and, although divided among the three Bonding Wires, the current in each Bonding Wire is still substantial (in other embodiments, when no fault injection takes place, the supply current may be low, and only one Bonding Wire 110 is needed; in an embodiment, during fault injection, the current may be significantly higher). We designate the currents through the three Bonding Wires 110 as Ipc-a, Ipc-b and Ipc-c.

To induce Operational Voltage glitches that are strong enough to disrupt the proper operation of Protected Circuit 104, Capacitor 107 must be quickly charged or discharged, which implies a large voltage drop on the Wire Bonds 110 (to force a large di/dt through the inductance). Hence, the spikes that the Hacker applies to the PCB Vdd-Trace 108 are much stronger than the spikes observed on the Operational Voltage Waveform. For example, in some embodiments, to induce a 0.5V spike on the Power-Supply Input 106 of Protected Circuit 104, the hacker may apply spikes of several volts, positive or negative, on the PCB Vdd-Trace.

To detect security attacks, IC 102 further comprises a Voltage-Sense circuit 114. A Voltage-Sense Input 116 of the Voltage-Sense Circuit is coupled through an electrical connection that is separate from the electrical connection used for connecting Protected Circuit 104. In the present example, the electrical connection of Voltage-Sense Circuit 114 comprises a Bonding Wire 120 (which is separate from Bonding Wires 110).

Voltage-Sense Input 116 of Voltage-Sense Circuit 114 is coupled through Bonding Wire 120 and a Pad 122, to the PCB Vdd-Trace 108 (the current through the Voltage-Sense input is negligible and, hence, the voltage at input 116 of the Sense Circuit closely matches the voltage on the PCB Vdd-Trace). We refer to the voltage level at the Voltage-Sense Input 116 as Sense Voltage, and to the waveform over time of the Sense Voltage as Sense Voltage Waveform. Since the Sense Voltage closely matches the voltage on the PCB Vdd-Trace 108, the Voltage Sense Circuit will be able to easily detect aggressive modifications of the voltage on the PCB Vdd Trace. In an embodiment, the Voltage-Sense Circuit 114 compares the Sense Voltage to pre-defined thresholds (e.g., 2*Vdd and 0.2*Vdd) to detect spikes that are indirectly applied to the Protected-Circuit Power-Supply Input 106 and, responsively, generates a security-attack warning.

In some embodiments, circuitry in IC 102 may, responsively to such security-attack warnings, initiate security protection measures, such as a reset, or a permanent erasure of sensitive data. In an embodiment, the Voltage-Sense circuit is configured to take the security protection measures, in addition to, or instead of, sending a warning to the IC.

The configuration of Attack-Resilient Electronic Device 100 illustrated in FIG. 1 and described above is cited by way of example. Other configurations may be used in alternative embodiments. For example, in some embodiments, IC 100 is packaged in a leadframe, and Bonding Wires 110 connect pads in the leadframe to pads in the IC. In embodiments, the number of Bonding Wires that connect the Protected Circuit Power Input to the Vdd Power Trace may be less than (including one) or more than 3.

### Differential Detection

Attack-Resilient Electronic Device 100, illustrated in FIG. 1, detects security attacks on the Electronic Device according to the sense voltage at the input of the Voltage Sense Circuit 114, which closely follows the voltage on the PCB Vdd-Trace 108. As explained, a hacker should insert large voltage glitches on the PCB Vdd-Trace to achieve operational-voltage glitches that may disrupt the operation of the Protected-Circuit 104.

In embodiments, however, attack detection may be achieved if the Sense Circuit also (or additionally) inspects the difference between the Operational Voltage Waveform and the Sense Voltage Waveform. Ignoring any voltage drop across Bonding Wire 120 and Pad 122 (since the current consumption of the Sense circuit is negligible), this difference is proportional to the rate in which the Operational Waveform changes; in other words, the difference is indicative to the sum of first derivative of the current Ipc multiplied by the inductance of the wiring bonds, and the current multiplied by the resistance.

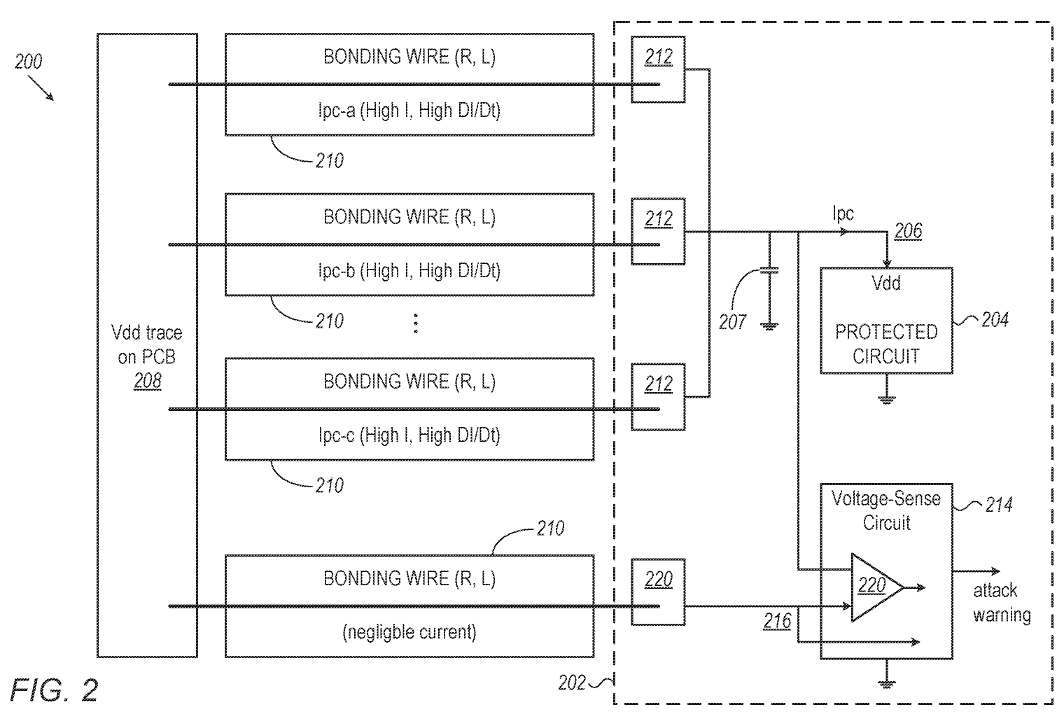

FIG. 2 is a block diagram that schematically illustrates a differential-detection attack-resilient Electronic Device 200, in accordance with an embodiment of the present invention.

Similarly to Electronic Device 100, Electronic Device 200 comprises a Protected Circuit 204 that receives, on a Protected Circuit Power Input 206 that is coupled to ground by a capacitor 207, an Ipc supply current from a PCB Vdd Trace 208, through one or more Bonding Wires 210 and through Pads 202.

A Voltage-Sense Circuit 214 receives a Sense Voltage on a Voltage-Sense Input 216, from PCB Vdd Trace 208, through a Bonding Wire 210 and through a Pad 220.

Unlike Voltage-Sense Circuit 114 (FIG. 1), Voltage-Sense Circuit 214 comprises a Voltage-Comparator 220 that compares the Voltage-Sense Waveform (on input 216) to the Protected Circuit Operational Voltage Waveform (on Power Input 206). In embodiments, the Sense Circuit detects a security attack responsively to a comparison between the Voltage-Sense waveform and the Protected Circuit Voltage waveform.

In some embodiments, the Sense Circuit warns that a Security Attack is in progress when the absolute value of the difference between the Voltage-Sense waveform and the Protected Circuit Voltage waveform is above a preset threshold. In other embodiments, different thresholds may be set for positive and negative glitches. In yet other embodiments, the Sense Circuit may comprise a multi-source attack detection circuit, including a first threshold for the positive-edges of the glitches, a second threshold for the negative-edges of the glitches, a third threshold for a maximum value of the Sense Voltage Waveforms and a fourth threshold for a minimum value of the Sense Voltage Waveform. In an embodiment, the thresholds are programmable.

### Supplying Power to The Sense Circuit

The configurations of Electronic Devices 100 and 200 described above do not address the power supply of the Sense Circuit. It should be noted that if the supply input of the Sense Circuit is the operational voltage, glitches that are induced on the operational voltage may impair the operation of the Sense Circuit. In some embodiments the Sense Circuit is, therefore, configured to operate at voltages much below the minimum voltage of the Protected Circuit.

In another embodiment, the power input of the Sense Circuit is the Sense input; the power consumption of the Sense Circuit is considerably lower than that of the Protected Circuit, and, hence, the Sense Circuit Supply voltage will closely follow the PCB Vdd Power Trace.

### Methods

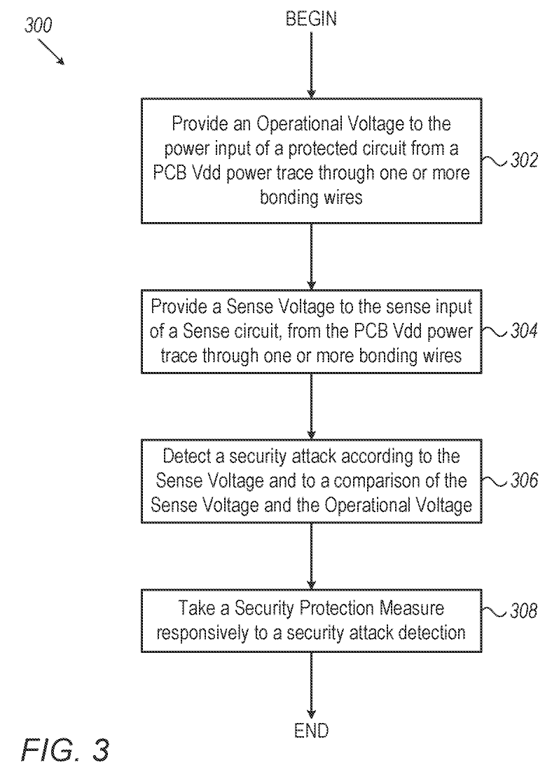

FIG. 3 is a flowchart 300 that schematically illustrates a method for Security Attack detection, in accordance with an embodiment of the present invention. The method is executed by Attack-Resilient Electronic Device 200 (FIG. 2), including Sense Circuit 214 therein.

The flowchart starts at a Provide Operational Voltage operation 302, wherein the Electronic Device routes an Operational Voltage, from a Vdd trace in the PCB and through one or more Bonding Wires, to the power supply input of Protected Circuit 204.

Next, at a Provide Sense Voltage operation 304, the Electronic Device routes a Sense Voltage, from the Vdd trace in the PCB, through one or more Bonding Wires, to a Voltage Sense input of the Voltage-Sense Circuit 214.

According to the example flowchart illustrated in FIG. 3, a Hacker cannot directly access the Protected Core and, hence, to apply glitches on the Operational Voltage, the Hacker applies glitches on the PCB Vdd Trace. However, due to the inductance of the Bonding Wires (typically in the order of several milli-Henry), the glitches that the Hacker should apply on PCB Vdd Trace should be much larger, reaching, in some embodiments, several volts (positive and negative).

The Sense Circuit, by monitoring the Sense Voltage, (which is closely matched to the PCB Vdd Trace voltage), can, thus, detect Vdd-glitch security attacks that the Hacker initiates. In addition, by monitoring a comparison of the Operational Voltage and the Sense Voltage, the Sense Circuit can get a direct measure of the rate of change of the Protected circuit supply current, which may indicate a Vdd-glitch attack.

In a Detect a Security Attack operation 306, the Sense Circuit detects a Security Attack according to preset criteria, which may include comparing of the Sense Voltage to preset thresholds such as transistor threshold voltages, comparing the difference between the Operational Voltage and the Sense Voltage to a preset threshold, such as a transistor threshold voltage, and others.

Lastly, at a Take Security Protection Measure operation 308, the Electronic Device may protect again the security attack. In an embodiment, the Electronic Device Resets; in another embodiment, the Electronic Device may erase sensitive information or, in yet another embodiment, blow a fuse to disable access to the Protected Core. After operation 308 the flowchart ends.

The configuration of flowchart 300 illustrated in FIG. 3 and described herein above is cited by way of example. Other configurations may be used in alternative embodiments. For example, in an embodiment, the Sense Circuit is not connected to the operational voltage, and detects a security attack according to the sense voltage only.

The configurations of Electronic Devices 100 and 200, including Voltage Sense circuit 114, 214, and the method of flowchart 300, illustrated in FIGS. 1 through 3 and described hereinabove, are example configurations and methods that are shown purely for the sake of conceptual clarity. Any other suitable configurations and methods can be used in alternative embodiments. The different elements of IC 102 and IC 202 may be implemented in an integrated circuit, such as an application specific integrated circuit (ASIC) or a field-programmable gate-array (FPGA).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An electronic device, comprising:
a power-supply input;
a protected circuit, configured to draw current from the power-supply input, thereby obtaining from the power-supply input an operational voltage waveform; and
a voltage sense circuit, configured to receive, from the power-supply input, a sense voltage waveform that differs from the operational voltage waveform, via a second electrical connection that is separate from the first electrical connection, and to detect a security attack on the protected circuit responsively to the sense voltage waveform.

2. The electronic device according to claim 1, wherein the first electrical connection comprises a first number of bonding wires, and wherein the second electrical connection comprises a second number of bonding wires.

3. The electronic device according to claim 1, wherein the voltage sense circuit is configured to detect the security attack responsively to the sense voltage waveform and to a comparison of the sense voltage waveform and the operational voltage waveform.

4. The electronic device according to claim 1, wherein the voltage sense circuit is configured to detect the security attack based on the sense voltage waveform, independently of the operational voltage waveform.

5. The electronic device according to claim 1, wherein the voltage sense circuit is configured to initiate a security protection measure responsively to detecting the security attack.

6. A method, comprising:
in a protected circuit in an electronic device, drawing current from a power-supply input, thereby obtaining from the power-supply input an operational voltage waveform; and
in a voltage sense circuit in the electronic device, receiving from the power-supply input a sense voltage waveform that differs from the operational voltage waveform, via a second electrical connection that is separate from the first electrical connection, and detecting a security attack on the protected circuit responsively to the sense voltage waveform.

7. The method according to claim 6, wherein the first electrical connection comprises a first number of bonding wires, and wherein the second electrical connection comprises a second number of bonding wires.

8. The method according to claim 6, wherein detecting the security attack is performed responsively to the sense voltage waveform and to a comparison of the sense voltage waveform and the operational voltage waveform.

9. The method according to claim 6, wherein detecting the security attack is performed based on the sense voltage waveform, independently of the operational voltage waveform.

10. The method according to claim 6, and comprising initiating a security protection measure responsively to detecting the security attack.
